(19) United States
(12) Patent Application Publication
(10) Pub. No.: US 2021/0153539 A1
(43) Pub. Date: May 27, 2021

(54) PRODUCTION METHOD FOR PURE COCONUT POWDER WITHOUT THE USE OF FOREIGN ADDITIVES

(71) Applicant: PULAU SAMBU SINGAPORE PTE LTD, Tanglin Shopping Centre (SG)

(72) Inventor: Mei Qiu Li, Tanglin Shopping Centre (SG)

(73) Assignee: PULAU SAMBU SINGAPORE PTE LTD, Tanglin Shopping Centre (SG)

(21) Appl. No.: 17/046,654

(22) PCT Filed: Apr. 9, 2019
(86) PCT No.: PCT/SG2019/050199

§ 371 Date: Oct. 9, 2020

Related U.S. Application Data
(60) Provisional application No. 62/655,517, filed on Apr. 10, 2018.

(51) Int. Cl. A23P 10/40; A23L 25/00; A23B 7/024; A23L 2/39; A23L 19/00; A23B 7/026

(52) U.S. Cl. CPC A23P 10/40; A23L 25/30; A23B 7/026; A23L 2/39; A23L 19/01; A23B 7/024

(57) ABSTRACT

The present invention involves a new method to produce pure coconut powder. Under ultra-high-pressure condition, the fiber of coconut meat shortens and puffs, consequently, its specific surface area increases. This enhances its ability to absorb fat, which enables the natural fiber in coconut meat to act as the excipient (carrier) of spray drying or lyophilization (whereas in traditional coconut milk powder formulations, art starch hydrolysates are added to act as the excipient). Further the natural fiber replaces emulsifiers and anti-caking agents used in the traditional formula. This produces a pure coconut powder that has no foreign additives, but at the same time has a good instant solubility and reconstitution stability, as well as possesses rich dietary fiber. This invention produces no by-product (desiccated coconut), realizing the zero-residue processing of coconut meat.

### RELATED APPLICATIONS

This application is a U.S. National Phase under 35 U.S.C. § 371 of International Application PCT/SG2019/050199, filed on Apr. 9, 2019, which claims priority to U.S. Provisional Application 62/655,517, filed on Apr. 10, 2018, which is herein incorporated by reference in its entirety.

### TECHNICAL FIELD

The present invention provides a novel method of producing a pure coconut powder. The processing method uses ultra-high pressure homogenization to crush and puff the fiber in coconut meat so that the fat in the coconut meat is absorbed on the fiber, which thus attains an emulsification-like effect that produces a stable superfine homogenate.

### BACKGROUND

Traditionally, coconut milk powder is produced by using the coconut milk extracted from coconut meat as its raw material, and involves the addition of starch hydrolysis products (such as dextrin) as an excipient (carrier), and milk protein (such as sodium caseinate) as its emulsifier, supplemented with other additives. However, this coconut milk powder is unsuitable for people allergic or sensitive to milk protein.

To avoid milk protein allergy, a vegan coconut milk powder has recently been developed, which involves adding massive amount of cassava starch into the coconut milk as an excipient and substitute for the sodium caseinate. However, because this product contains massive amount of cassava starch, it has a fat content below 55%, and its instant solubility and reconstitution stability are also poor. And this product cannot be considered a pure coconut milk powder because of the addition of foreign additives (not originating from coconut).

In the production of traditional coconut milk powder, the process of extracting coconut milk leaves behind wet coconut resides. Thus, additional production facilities and equipment have to be installed for drying these residues into a low value-added low fat desiccated coconut.

In addition, traditional coconut milk powder preparation processes produce a coconut milk powder lacking dietary fiber. Dietary fiber in coconut meat is beneficial to the human body so it is desirable to be able to have a coconut milk powder having the dietary fiber.

Coconut flour is often the by-product of coconut processing, and it is made from pulverizing the coconut cake, which results from pressing oil from desiccated coconut. Although this coconut flour contains rich dietary fiber and protein, the coconut fiber particles in it are still relatively coarse, rendering them unable to provide the necessary physiological functions of suitable dietary fiber. Further, the texture of this product is coarse and dry, and when it is dispersed in water, it separates too quickly.

Therefore, there remains a need for a processing method that does not require complex unit operation to realize the zero-residue processing of coconut meat, and does not require any foreign additives but can obtain a powdered product that maintains the nutritional content similar to natural coconut meat. Further, the product also has a good taste without a fibrous mouth-feel, but also possesses good instant solubility and can be easily dispersed in water. At the same time, after reconstitution, the product should have excellent stability in water, and will not easily sediment and stratify. It can also be used as the raw materials for various foods that need to increase their coconut flavor. The present invention meets these needs.

### SUMMARY OF THE INVENTION

The present invention employs ultra-high pressure processing so that in ultra-high pressure homogenization, the fiber of coconut meat shortens as it collapses, and puffs that increases its specific surface area increases. This enhances its ability to absorb fat. At the same time, in ultra-high pressure homogenization, fat and protein form into a stable emulsion. The natural protein can emulsify some of the oil drops, and the fibers with very large amounts of micro holes can absorb the rest of oil drops. The above combined effects render the final product (coconut powder) to possess good sensory quality (like smoothness and no feeling of fiber), as well as good dispersibility and stability in water. This attains the effect that has to be achieved in traditional method by using such additives as starch and its derivatives and sodium caseinate.

In the present invention, the various contents of the coconut homogenate in the ultra-high pressure homogenization, due to the cavitation effect, shear effect, turbulence effect, impact effect, and heating effect, fuse together to form a good emulsifying system, with pasteurization carried out at the same time. Whereas in traditional methods of coconut powder preparation, additional facilities and equipment for emulsification and pasteurization are needed.

The coconut powder produced by the present invention contains rich dietary fiber, which not only brings nutritional benefits, but also makes the product less likely to attach to the chamber wall in spray drying, and less likely to cake in storage. In the traditional method, the use of anti-caking agent (such as silicon dioxide powder and tricalcium phosphate) is needed to achieve such results.

The product of the present invention, through adding water and mechanical agitation or homogenization, can be made into coconut milk and other coconut flavored beverages (like coconut milk coffee); used as raw material for solid beverages with no milk protein; used as the raw material of candy, chocolate, biscuits, pastry, and ice-cream; and also used a supplement of dietary fiber.

The merits of this invention will be clearer through its detailed description below.

### BRIEF DESCRIPTION OF THE FIGURES

FIG. 1 is the process flow chart of the present invention.

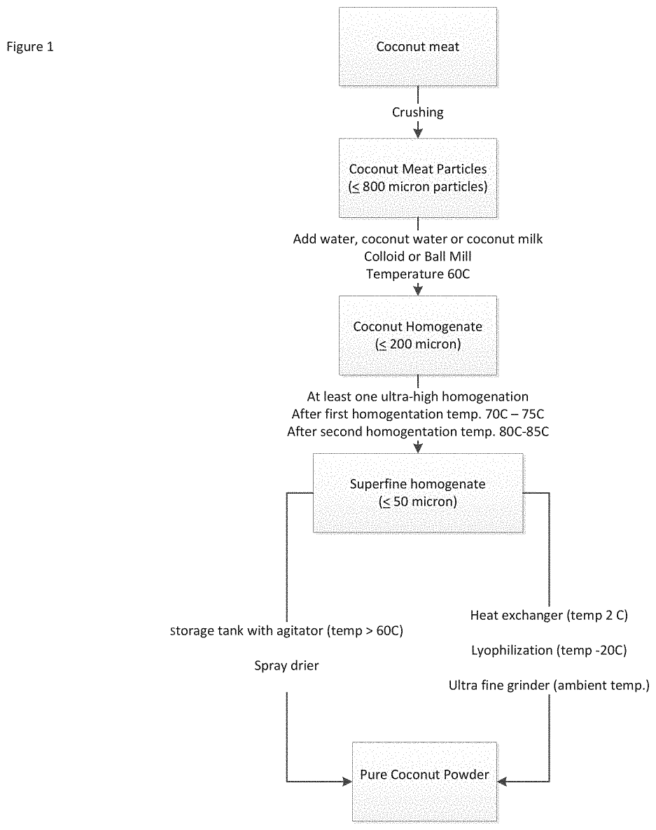

### DETAILED DESCRIPTION OF THE INVENTION

The terms in the present invention are used according to the following definitions.

The present invention provides methods of preparing a pure coconut powder where the method and the resulting coconut powder does not use or contain any foreign additives. Pure coconut power refers to the manufactured powder product that contains no foreign additives, and is obtained from coconut meat and drinking water, coconut water, or coconut milk only as its raw materials. Its fat content is 50%-75% (w/w); dietary fiber content is 10%-30% (w/w); and water content is ≤5% (w/w). “Dietary fiber” refers to the carbohydrate that cannot be digested and absorbed by the small intestines in humans. However, it is significant for health, and is either naturally existing in plants or extracted with a polymerization degree of >3. Dietary fiber includes cellulose, hemicellulose, pectin, polysaccharide, oligosaccharides, lignin, and relevant plant substances.

“No foreign additives”—means that nothing besides water or coconut derived products (coconut meat, coconut water, coconut milk) are used in the process or contained in the product. Generally, “foreign additives” refers to starch, starch hydrolysates (such as dextrin), modified starch, sodium caseinate, anti-caking agent, and other food additives.

The methods involve obtaining coconut meat and processing it so that the coconut meat is sized to have coconut meat particles having a diameter less than or equal to about 800 μm. “Coconut meat” refers to the endosperm of coconuts, which is the white flesh of a mature coconut after removing its husk, shell and paring. The processes of the invention can use fresh, as well as frozen coconut meat. In addition, the coconut meat can also include processed coconut meat (such as desiccated coconut), low-fat desiccated coconut, coconut cake (which is produced after oil is extracted (or through solvent extraction)), or coconut flour (obtained from coconut cake).

The coconut meat is crushed to provide “coconut meat particles,” which means that under mechanical effect, the particle diameter of the wet coconut meat is reduced, preferably to particles having an average particle diameter less than or equal to about 800 μm. “Average particle diameter of coconut meat” refers to the arithmetic mean of the particle diameter of coconut meat. Preferably the average particle diameter of the wet coconut meat is ≤800 μm to ≤200 μm. More preferably the average particle diameter is ≤400 μm to ≤200 μm and yet more preferably is ≤200 μm. The optimal average particle diameter is determined according to the crushing effect of the equipment and the performance of the equipment for the subsequent coconut homogenate preparation. As for the coconut residues left over from the extraction of coconut milk, or the coconut cake after extracting oil from the desiccated coconut, if their particle diameter is ≥800 μm, corresponding crushing or pulverizing equipment (such as airflow pulverizer, colloid mill, and medium mill) is needed to reduce their particle diameter so their average particle diameter is ≤800 μm.

Then the coconut meat particles are processed to form a “coconut homogenate.” “Coconut homogenate” refers to the mixture of coconut meat and water, coconut water or coconut milk. After grinding (such as colloid milling, ball milling, or medium milling), it is a puree where the average particle diameter is about ≤200 μm.

The preparation of the coconut homogenate is to ensure that the coconut meat particles can pass through the ultra-high pressure homogenization equipment. The ultra-high-pressure homogenization equipment can be a ultra-high pressure homogenizer and/or a micro jet high-pressure homogenizer. Either one or both can be used. For example the process may utilize more than one ultra-high pressure homogenization steps. So both steps could be performed in an ultra-high pressure homogenizer, both in a micro get high pressure homogenizer or one step in each piece of equipment.

Obviously, the smaller the particle diameter of the coconut meat in the prepared coconut homogenate, the more advantageous it is for the preparation of the superfine homogenate. A relatively good average particle diameter of the coconut meat in the coconut homogenate is ≤200 μm, a more preferred average particle diameter is ≤125 μm, and a more preferable average particle diameter is ≤115 μm. This processing step involves the addition of water, coconut water or coconut milk to the coconut meat and preferably circulating in a colloid mill (a ball mill may also be used). The processing in the colloid mill causes the temperature of the coconut meat particles to rise to about 60° C. The water used in preparing the coconut homogenate is preferably drinking water. It can include any potable water such as filtered water, purified water or spring water. “Coconut water” refers to potable coconut water, including the liquid in the shells of green coconuts and mature coconuts, including fresh, frozen, concentrated, and sterilized coconut water. “Coconut milk” refers to the white liquid obtained from pressing (such as using hydraulic press, screw press, or belt press) fresh coconut meat after it has been crushed with or without water. This includes fresh, and frozen coconut milk, as well as preserved coconut milk.

The main function of water, coconut water, or coconut milk is to give the coconut homogenate and superfine homogenate a better fluidity in the preparation process and the subsequent process of spray drying. If coconut water or coconut milk is used instead of plain drinking water, it further has the effect of increasing the nutrition of the pure coconut powder.

The coconut homogenate is then processed to produce a “superfine homogenate.” “Superfine homogenate” refers to the slurry in which the average particle diameter of the coconut meat in the coconut homogenate after ultra-high pressure processing is ≤50 μm. The content of dry material in the superfine homogenate is ≤35% (w/w). The coconut homogenate is subjected to at least one, preferably two ultra-high pressure homogenization steps to produce the superfine homogenate. The ultra-high pressure homogenization step is preferably performed at a homogenization pressure of greater than or equal to 90 MPa. To produce a superfine homogenate whose average particle diameter is ≤50 μm, the homogenate will be homogenized under a certain pressure several times, or in other embodiments, can be homogenized the first time in a lower pressure (≤90 MPa) and then followed by a higher pressure homogenization. The processes of the invention preferably use a homogenization pressure of about ≥90 MPa. Preferably the pressure is about ≥110 MPa, and more preferably is about ≥120 MPa. The Ultra-high pressure homogenizer makes the coconut particle sizes finer/smaller, which improves its ability to absorb oil drops, which also improves the stability of the finalized coconut powder as well as preserve the mouth feeling of the coconut powder when its rehydrated and consumed. Processes of the invention can use one or more, preferably two, ultra-high homogenization pressure steps. The number of homogenization steps to be employed is determined according to the particle diameter of the incoming material of coconut meat and that of outgoing material of coconut meat. For example, if the average coconut meat particle diameter of the incoming material ranges from ≤200 μm to about ≤115 μm; and the average coconut meat particle diameter of the outgoing material ranges from about ≤50 μm to about ≤25 μm, to achieve these objectives, a fixed pressure (≥90 MPa) can be selected for the homogenization pressure, or in some embodiments a lower pressure (≤90 MPa) can be selected first, followed by a higher pressure homogenization (≥90 MPa), and then an even higher pressure (≥110 MPa).

The ultra-high pressure homogenization steps maybe carried out under fixed (the pressure is the same throughout the step) or under variable pressure (the pressure increases or decreases, for example, throughout the homogenization process step.

The temperature of the material increases about 10° C. per circulation at 100 MPa. The higher the pressure and the more ultra-high pressure homogenization steps, the higher the temperature the material will become. To achieve the pasteurization of the superfine homogenate, the initial temperature of the material reaches >50° C. through heating equipment (such as plate heat exchangers); and to avoid the protein denaturation and loss of the nutrient content of the superfine homogenate resulting from its being exposed to high temperature for a long time, the material that comes out from ultra-high pressure homogenizer should immediately be cooled down to a temperature of ≤85° C. through a heat exchanger (such as plate or tube heat exchanger). “Pasteurization” refers to the process that uses lower temperature to kill pathogens and bacteria that cause food spoilage, preferably without changing the nutrients and flavor of the food.

In order to perform a simultaneous pasteurization of the superfine homogenate in the ultra-high pressure homogenization, and to avoid the protein denaturation and loss of the nutrients of the coconut meat, a preferred operating temperature ranges from about 50° C.-85° C., more preferably, about 70° C.-84° C., and most preferably ranges from about 75° C.-80° C. For this purpose, both the incoming material and outgoing material (material before and after the ultra-high homogenization steps) pass through a heat exchanger (such as plate or tube heat exchangers).

Therefore, processes of the invention utilize a heat exchanger to keep the temperature of the material to around 60° C. to around 85° C. If the temperature is higher than 85° C., the proteins in the coconut will be denatured and other nutrients will be lost. The material can be exposed to the heat exchanger at any time in the process as necessary. Generally, it will be passed through the heat exchanger after the ultra-high pressure homogenization step(s) and before the material is lyophilized.

After the material is subjected to the ultra-high pressure homogenization steps to make the superfine homogenate, it can be stored in a storage tank that has an agitator. The material at this stage is a slurry. Thereafter, the material is subjected to either a spray dryer or lyophilization and ultrafine grinder or pulverizer (such as superfine pulverization or airflow pulverization) to produce the pure coconut powder.

“Spray drying” refers to atomization of the superfine homogenate through pressure, rotary, or airflow, as well as producing a powder by rapidly drying with a hot gas.

“Lyophilization” is also called sublimation drying. It is a drying method that freezes materials containing water to below their freezing point, and then reducing the surrounding pressure to allow the frozen water in the material to move directly from the frozen solid phase to the gas phase.

The function of the spray drying or lyophilization step is to remove moisture from the superfine homogenate and to produce the pure coconut powder. Since microbe growth cannot occur in coconut powder when the moisture content is less than 5%, it is preferable that the superfine homogenate is subjected to spray drying or lyophilization to ensure that it has a moisture content of less than 5%. The moisture content can be adjusted so that it is less than 5%, depending on the characteristics desired by the customer (moisture content will affect the coconut powder's characteristics, such as bulk density, flowability and tapped density. After lyophilization the obtained coconut power can also be pulverized according to conventional, well understood pulverization processes. “Pulverize” means that under mechanical effect, the particle diameter of the dry coconut meat is reduced.

When spray driers are used, using higher temperatures of inlet or outlet air lowers the moisture content. For instance, referring to example 1, the moisture content of the product was 2.5%, which was achieved when the inlet air temperature was 190° C. and the outlet air temperature was 90° C. If the inlet air temperature in increased to 200° C. and the outlet air temperature remains the same (90° C.), or the inlet air temperature remains the same (190° C.) and the outlet air temperature is increased to 95° C., the moisture content in the coconut powder will be reduced and range from 1.0% to 1.8%. Thus the amount of moisture can be altered by changing the temperatures of the inlet and outlet air temperatures.

By utilizing the spray drier, the resulting pure coconut powder can be subjected to long-term storage and is also easy to transport. A suitable inlet air temperature to be utilized in the spray dryer ranges from about 140° C.-230° C., more preferably ranges from about 150° C.-200° C., and most preferably ranges from about 170° C.-190° C. A suitable outlet air temperature ranges from about 60° C.-100° C., more preferably about 75° C.-90° C., and most preferably about 80° C.-85° C.

If the lyophilizer is used, a product with lower moisture can be obtained if the process time is increased. Referring to example 4, the moisture content decreases to 2.5% when lyophilized for 48 hours. If this process time is decreased to 40 hours, the moisture content will increase to 3-4.5%. Thus the amount of moisture can be altered by changing the lyophilization process time.

Accordingly, the superfine homogenate is exposed to either spray drying or lyophilization to reduce the moisture content and obtain a pure coconut powder having a moisture content less than or equal to 5%, less than or equal to 4%, less than or equal to 3%, less than or equal to 2%, or range from 1-5%, 1-4%, 1 to 3%, 1 to 2.5%, or 1 to 2.0% or 1 to 1.8%.

The resulting pure coconut powder can be easily dispersed/reconstituted in water. The dispersibility and stability of pure coconut powder in water can be tested by, for example, taking 1 part of pure coconut powder and adding to 3-10 parts of water (water is 60° C.-80° C.), gently stir the solution and watch its dispersion; and after standing still for 10-30 minutes, observe its stratification.

In addition, the pure coconut powder has a fat content of about 50% to 75% (w/w); has a dietary fiber content of about 10% to 30% (w/w) and a water content of about less than or equal to 5% (w/w). The amount of fat and dietary fiber in the coconut powder can be altered by regulating the ratio of coconut meat to water or coconut water or coconut milk. This can be done in the crushing or pulverizing of the coconut meat, the preparation of coconut homogenate, or the preparation of superfine homogenate.

In order to reduce the energy consumption of spray drying, a relatively good dry matter content in the superfine homogenate is 15%-35% (w/w), more preferably 15%-30% (w/w), and even more preferably 20%-25% (w/w). Dry matter content in superfine homogenate” is calculated according to this equation:

$$Dry matter content in superfine homogenate ( \% , w / w )$$

$$Weigt of superfine homogenate dried to = \frac{constant weight at 105 °C .}{Weight of superfine homogenate} \times 100 \%$$

In order for the pure coconut powder to have a good texture and excellent dispersibility and stability in water, a suitable dietary fiber content is 10%-30%, more preferably 12%-25%, and even more preferably 15%-20%. A suitable fat content is 50%-75%, more preferably 55%-70%, and even more preferably 60%-65%.

Benefits of the invention result from in part to the cavitation effect, shear effect, turbulence effect of the ultra-high pressure homogenization equipment on the coconut materials, together with its ability to reduce the particle diameter of the coconut meat, which all work together to enable the protein and fat in the coconut to form a more stable emulsion. The dietary fiber puffs in the process of ultra-high pressure, which increases its surface area, thus enhancing its ability to absorb fat. In addition, use of the ultra-high pressure homogenization equipment also assists in ensuring the smooth performance of the subsequent spray drying process as well as increasing the yield (such as causing little to no sticking to the material in the spray drying chamber). In addition, the process of the invention also improves the sensory characteristic of the pure coconut powder product, as well as improves its dispersiblity and stability in water. And at the same time, the process is beneficial to raising the physiological activity because it increases the water retention ability of the dietary fiber of the coconut meat.

### EXAMPLES

### Example 1: The Production of Pure Coconut Powder with Fresh Coconut Meat as Raw Material

1. Coconut homogenate: (1) 1000 kilograms of cleanly washed coconut meat without paring (fat 28%, dietary fiber 11%, water 54%, and protein 3%). (2) Add 1000 kilograms of water to the coconut meat, and after crushing it, circulate it in the colloid mill for 6 minutes. A ball mill could alternatively be used instead of a colloid mill, but colloid mill is preferred. At this stage, the temperature of the material is 60° C., and the average particle diameter of the coconut meat is 140-190 μm.
2. Superfine homogenate: (1) 1900 kilograms of the above prepared coconut homogenate at 60° C. passes through the 100 MPa ultra-high pressure homogenization equipment, and the temperature of the material increases to 70° C. (2) The homogenate passes through another 120 MPa ultra-high pressure homogenization equipment, and the temperature of the material reaches 80° C.; the material that is obtained now is the superfine homogenate (dry matter content 23%). The two passes through the ultra-high pressure homogenization equipment render the particles to the desired size. Preferably the particles are less than 50 μm. Some particles will be less than 25 μm or even less then 35 μm, however, all particles are less than 50 μm.
3. Spray drying: (1) The above prepared superfine homogenate is transferred to a storage tank using a food grade pump. The rotation speed of the storage tank is 60 rmp, and its temperature is maintained at 80° C. (2) The operational condition of the spray drying: inlet air temperature, 190° C.; outlet air temperature, 90° C.
   The physicochemical indicators for the finished product: according to the above process, 390 kilograms of the pure coconut powder (fat content 65%, dietary fiber 26%, protein content 7%, and water content 2.5%) is obtained.

### Example 2: The Production of Pure Coconut Powder with Fresh Coconut and Coconut Water as Raw Materials

1. Coconut homogenate: (1) 1000 kilograms of cleanly washed coconut meat without paring (fat 28%, dietary fiber 11%, water 54%, protein 3%), which is crushed. (2)) Add 1500 kilograms of coconut water (fat 0.1%, protein 0.1%, total sugar content 2.6%, and ash content 0.5%) to the coconut meat and crush it again. (3) Circulate it in the colloid mill for 8 minutes. At this stage, the temperature of the material is 65° C., and the average particle diameter of the coconut meat is 160-190 μm.
2. Superfine homogenate: (1) 2400 kilograms of the above prepared coconut homogenate at 65° C. passes through the 100 MPa ultra-high pressure homogenization equipment, and the temperature of the material increases to 72° C. (2) The homogenate passes through another 120 MPa ultra-high homogenization equipment, and the temperature of the material at this stage reaches 84° C.; the material that is now obtained is the superfine homogenate (dry matter content 21%).
3. Spray drying: (1) The above prepared superfine homogenate is transferred to a storage tank using a food grade pump. The rotation speed of the storage tank is 60 rpm, and its temperature is maintained at 84° C. (2) The operational condition of spray drying is that the inlet air temperature is 180° C., and that of the outlet air temperature is 86° C. The physicochemical indicators for the finished product: according to the above process, 425 kilograms of pure coconut powder (fat content 65%, dietary fiber 25%, protein content 6.8%, and water content 2%) is obtained.

### Example 3: The Production of Pure Coconut Powder with Desiccated Coconut and Coconut Milk as Raw Materials

1. Coconut homogenate: (1) 120 kilograms of commercial grade low-fat desiccated coconut (fat content 36%, dietary fiber 50%, water content 3%, protein content 4%, and average particle diameter ≤1 mm). The average particle diameter of desiccated coconut is reduced to ≤150 μm by means of an airflow pulverizer, from which 100 kilograms of low-fat desiccated coconut flour is obtained. (2) Feed it into an agitator tank, and then add 1000 kilograms of commercial grade coconut milk (fat content 30%, protein content 3%, and dry matter content 38%) and 600 kilograms of drinking water. Start the agitator tank, and maintain a rotation speed of 50 rpm and increase the temperature to 60° C.
2. Superfine homogenate: (1) 1615 kilograms of the above prepared coconut homogenate at 60° C. passes through the 100 MPa ultra-high pressure homogenization equipment, and the temperature of the material increases to 70° C. (2) The homogenate passes through another 110 MPa ultra-high homogenization equipment, and the temperature of the material at this stage reaches 80° C.; the material that is now obtained is the superfine homogenate (the dry matter content is 28%).
3. Spray drying: (1) The above prepared superfine homogenate is transferred to a storage tank using a food grade pump. The rotation speed of the storage tank is 60 rpm, and its temperature is maintained at 80° C. (2) The operational condition of spray drying is that the inlet air temperature is 180° C., and that of the outlet air temperature is 85° C.
   The physicochemical indicators of the finished product: according to the above process, 390 kilograms of pure coconut powder (fat content 70%, dietary fiber 12%, protein content 7%, and water content 2%) is obtained.

### Example 4: The Production of Pure Coconut Powder with Coconut Cake, Coconut Milk and Coconut Water as Raw Materials

1. Preparation of coconut homogenate: (1) 120 kilograms of commercial grade coconut cake (fat content 14%, dietary fiber 25%, protein content 20%, water content 8%). The average particle diameter of coconut cake is reduced to ≤150 μm by means of an airflow pulverizer, from which 100 kilograms of coconut cake powder is obtained. (2) Feed the coconut cake powder into an agitator tank, and then add 1000 kilograms of commercial grade coconut milk (fat content 30%, protein content 3%, and dry matter content 38%) and 600 kilograms of coconut water (fat 0.1%, protein content 0.1%, total sugar content 2.6%, and ash content 0.6%). Start the agitator tank, and maintain a rotation speed of 50 rpm and increase the temperature to 60° C. The agitator is run for about 30 minutes.
2. Superfine homogenate: (1) 1615 kilograms of the above prepared coconut homogenate at 60° C. passes through the 100 MPa ultra-high pressure homogenization equipment, and the temperature of the material increases to 75° C.; its temperature is then lowered to 65° C. as it passes through the heat exchanger. The material then passes through another 150 MPa ultra-high pressure equipment, and the temperature of the material at this stage reaches 80° C.; the material that is now obtained is the superfine homogenate (dry matter content 29%).
3. Lyophilization: The above superfine homogenate is cooled down to 2° C., and after it is frozen at −20° C., it is lyophilized for 48 h. In any of the processes provided in the examples herein, either lyophilization or spray drying can be used.
4. Superfine pulverization: The above lyophilized material undergoes a superfine pulverization that finally produces the pure coconut powder. The lyophilized material is smashed by a miller and is then pulverized by an airflow pulverizer.
   The physicochemical indicators of the finished product: according to the above process, 410 kilograms of pure coconut powder (fat content 62%, dietary fiber content 12%, protein content 8%, and water content 2.5%) is obtained.

### Example 5: The Production of Pure Coconut Powder with Coconut Flour and Coconut Milk as Raw Materials

1. Coconut homogenate: (1) 100 kilograms of commercial grade coconut flour (fat content 10.7%, dietary fiber 40%, protein content 17.5%, water content 5%, and the average particle diameter of coconut meat ≤150 μm), and feed them into the agitator tank. (2) Add 800 kilograms of commercial grade coconut milk (fat content 30%, protein content 3%, and dry matter content 38%) and 900 kilograms of drinking water. Start the agitator tank, and maintain a rotation speed of 50 rpm and increase the temperature to 65° C. As the average coconut particle diameter in the coconut flour accords with the average particle diameter (115-200 μm) of the entering material for the above-mentioned ultra-high pressure homogenization equipment, milling equipment (such as colloid mills, ball mills, or medium mills) is not needed to reduce the average particle diameter of the coconut meat.
2. Superfine homogenate: (1) 1750 kilograms of the above prepared coconut homogenate at 65° C. passes through the 100 MPa ultra-high pressure homogenization equipment, and the temperature of the material increases to 77° C.; its temperature is then lowered to 65° C. as it passes through the heat exchanger. (2) The material then passes through another 150 MPa ultra-high pressure homogenization equipment, and the temperature of the material at this stage reaches 80° C.; the material that is now obtained is the superfine homogenate (the dry matter content is 22%).
3. Lyophilization: The above superfine homogenate is cooled down to 2° C., and after it is frozen at −20° C., it is lyophilized for 48 hours.
4. Superfine pulverization: The above lyophilized material undergoes a superfine pulverization that finally produces the pure coconut powder.
   The physicochemical indicators of the finished product: according to the above process, 340 kilograms of pure coconut powder (fat content 65%, dietary fiber 10%, protein content 10%, water content 2.5%) is obtained.

1. A method of preparing a coconut power that contains dietary fiber, the method comprising:
a) crushing coconut meat to obtain coconut meat particles having an average particle diameter less than or equal to about 800 μm;
b) taking the crushed coconut meat particles of step a) and processing to form a coconut homogenate wherein the average particle diameter of the coconut homogenate is less than or equal to about 200 μm;
c) processing the coconut homogenate produced in step b) to produce a superfine homogenate by subjecting the coconut homogenate to at least one ultra-high pressure homogenization step,
wherein the superfine homogenate comprises particles having an average particle diameter of less than or equal to about 50 μm;
d) processing the superfine homogenate produced in step c) to form a pure coconut powder;
wherein steps a) through d) are performed without the addition of foreign additives;
wherein the pure coconut powder can be easily dispersed/reconstituted in water; and
wherein the pure coconut powder has a fat content of about 50% to 75% (w/w); has a dietary fiber content of about 10% to 30% (w/w) and a water content of about less than or equal to 5% (w/w).

2. The process of claim 1 wherein the processing the superfine homogenate to form a pure coconut powder comprises spray drying.

3. The process of claim 1 wherein the processing the superfine homogenate to form a pure coconut powder comprises lyophilization.

4. The method of claim 1 wherein the ultra-high pressure homogenization step is performed at a homogenization pressure of greater than or equal to 90 MPa.

5. The method of claim 1 wherein the process comprises two or more ultra-high pressure homogenization steps.

6. The method of claim 1 wherein steps b) and c) are performed at a temperature of about 50° C. to 85° C.

7. The method of claim 1 wherein production of the coconut homogenate and superfine homogenate occurs at a temperature of ≤85° C.

8. The method of claim 7 wherein the temperature is controlled by heat exchangers.

9. The method of claim 1 wherein the coconut meat includes fresh coconut meat, frozen coconut meat, dried coconut meat, desiccated coconut, low-fat desiccated coconut, shredded coconut, coconut cake, and coconut flour.

10. The method of claim 1 wherein the superfine homogenate has a content of dry material at about ≤35% (w/w).

11. The method of claim 5 wherein, the two or more ultra-high pressure homogenization steps are carried out under the same pressure or are carried out under different pressures.

12. The method of claim 1 wherein the ultra-high pressure homogenization steps are carried out under fixed or under variable pressure.

13. The method of claim 1 wherein the process involves more than two homogenization steps.

14. The method of claim 2 wherein the spray drying uses an inlet air temperature of about 140° C.-230° C.; and an outlet air temperature of about 60° C.-100° C.

15. The method of claim 3 wherein the superfine homogenate is cooled down to about 2° C., and then is lyophilized and then pulverized to produce the pure coconut powder into pure coconut powder.
